(19) United States
(12) Patent Application Publication
(10) Pub. No.: US 2015/0233642 A1
(43) Pub. Date: Aug. 20, 2015

(54) CONCENTRIC HEATER FOR A CYLINDRICAL COMBUSTION TUBE

(71) Applicant: Leco Corporation, St. Joseph, MI (US)

(72) Inventor: Larry S. O'Brien, Stevensville, MI (US)

(73) Assignee: Leco Corporation

(21) Appl. No.: 14/607,692

(22) Filed: Jan. 28, 2015

Related U.S. Application Data
(60) Provisional application No. 61/940,650, filed on Feb. 17, 2014.

(51) Int. Cl. F27D 11/02

(52) U.S. Cl. CPC F27D 11/02

(57) ABSTRACT

A heater for a cylindrical combustion tube employed in an analytical instrument includes a curved resistive heating element shaped to at least partially surround a cylindrical combustion tube in spaced relationship to the combustion tube. The resistive heating element includes a plurality of alternately staggered slots to define serpentine current flow paths for the resistive heating element. In a preferred embodiment the resistive heating element circumscribes at least 180° and preferably is generally U-shaped.

### CROSS-REFERENCE TO RELATED APPLICATIONS

This application claims priority under 35 U.S.C. §119(e) and the benefit of U.S. Provisional Application No. 61/940,650 entitled CONCENTRIC HEATER FOR A CYLINDRICAL COMBUSTION TUBE, filed on Feb. 17, 2014, by Larry S. O'Brien, the entire disclosure of which is incorporated herein by reference.

### BACKGROUND OF THE INVENTION

The present invention relates to a combustion system and particularly to an improved heater for use with a combustion tube for fusing a specimen into a gaseous sample for subsequent analysis.

One combustion system used in an analyzer is disclosed in U.S. Pat. No. 3,923,464 issued Dec. 2, 1975, to Sitek et al and assigned to the present assignee. The system employs a carrier gas introduced into the combustion chamber of an induction furnace to oxidize a specimen and carry the resultant gas through the opposite end of the combustion chamber to an infrared cell for detection. A closed loop combustion system of this general type is also described in U.S. Pat. No. 3,985,505 issued Oct. 12, 1976, to R. L. Bredeweg, and assigned to the present assignee. Other combustion systems using vertically oriented open or closed end cylindrical combustion tubes likewise can benefit from the use of the resistive heater of this invention. Such systems are represented by U.S. Pat. No. 5,246,667 issued Sep. 21, 1993, and U.S. Pat. No. 5,236,353 issued Aug. 17, 1993. The disclosure of all of the above patents are incorporated herein by reference.

Although these systems provide excellent results in analyzing certain specimens, coal cannot be heated directly with radio frequency energy used in these systems since it is a non-conductor. As a result, accelerating agents, such as iron chips or powder, or tungsten, are required to be added to the sample. Further, the combustion chamber in such systems can be relatively small. Due to the fact that the coal is naturally combustible and creates an exothermic reaction during its combustion, it tends to sputter and some of the specimen can easily escape from the hot zone of the combustion chamber and not be broken down to provide an accurate analysis.

U.S. Pat. No. 4,282,183 issued Aug. 4, 1981, to R. L. Bredeweg et al. is assigned to the present assignee. U.S. Pat. No. 4,352,781 issued Oct. 5, 1982, and U.S. Pat. No. 5,064,617 issued Nov. 12, 1991, to O'Brien are also assigned to the present assignee. These patents are incorporated herein by reference and disclose improved combustion chambers having relatively large hot zones and an open end for receiving a combustion boat containing the specimen to be analyzed. The specimen gas is withdrawn from near an enclosed end of the combustion chamber by an eduction tube extending within the combustion chamber. The open end of the chamber is effectively sealed by a gas curtain such that the interior of the chamber is available to the operator for readily inserting and removing combustion boats containing specimens for combustion. The combustion systems represented by the above '183, '781, and '617 patents provide improved results, however, they utilize a plurality of rod-like heaters mounted in the furnace to surround the cylindrical combustion tube. As a result, several electrical connections through the furnace wall must be made to the individual heaters which requires relatively high assembly and service costs. Also the heaters must be matched to provide uniform heating of the combustion tube. Such rod heaters also consume relatively high operating power and do not have an extended service life.

There remains a need therefore, for an improved, efficient and reliable resistive heater for elongated combustion tubes of an analyzer. Particularly desirable is a heating system of the type used to fuse samples in an elongated cylindrical combustion tube and one which is capable of providing a hot zone with increased upper temperatures limits.

### SUMMARY OF THE INVENTION

The system of the present invention, overcomes the difficulties encountered by the prior art by providing a heater for a cylindrical combustion tube employed in an analytical instrument. The heater is a unitary curved resistive heating element shaped to at least partially surround a cylindrical combustion tube in spaced relationship to the combustion tube. The resistive heating element includes a plurality of alternately staggered slots to define a serpentine current flow path between opposite ends of the resistive heating element. A source of electrical power is coupled to said resistive element for heating the combustion tube. In a preferred embodiment, the curved resistive heating element circumscribes an arc of at least 180° and preferably is generally U-shaped in cross section. The resultant heater provides an easily assembled, highly efficient heater for a combustion furnace.

These and other features, objects and advantages of the present invention will become apparent upon reading the following description thereof together with reference to the accompanying drawings.

### BRIEF DESCRIPTION OF THE DRAWINGS

FIG. 1 is a schematic and block diagram view of an analyzer and furnace incorporating the combustion system of the present invention;

FIG. 2 is an enlarged fragmentary vertical cross-sectional view of the combustion furnace featuring the resistive heating element of the present invention;

FIG. 3 is an end elevational view of the resistive heating element of the present invention showing its relationship to a combustion tube;

FIG. 4 is a top plan view of the resistive heating element and combustion tube of the present invention;

FIG. 5 is a side elevational view of the resistive heating element and combustion tube of the present invention;

FIG. 6 is a perspective view of the resistive heating element and combustion tube shown for use in a vertically oriented furnace; and

FIG. 7 is a block and schematic electrical circuit diagram of the circuit of the resistive heating element.

### DETAILED DESCRIPTION OF THE PREFERRED EMBODIMENT

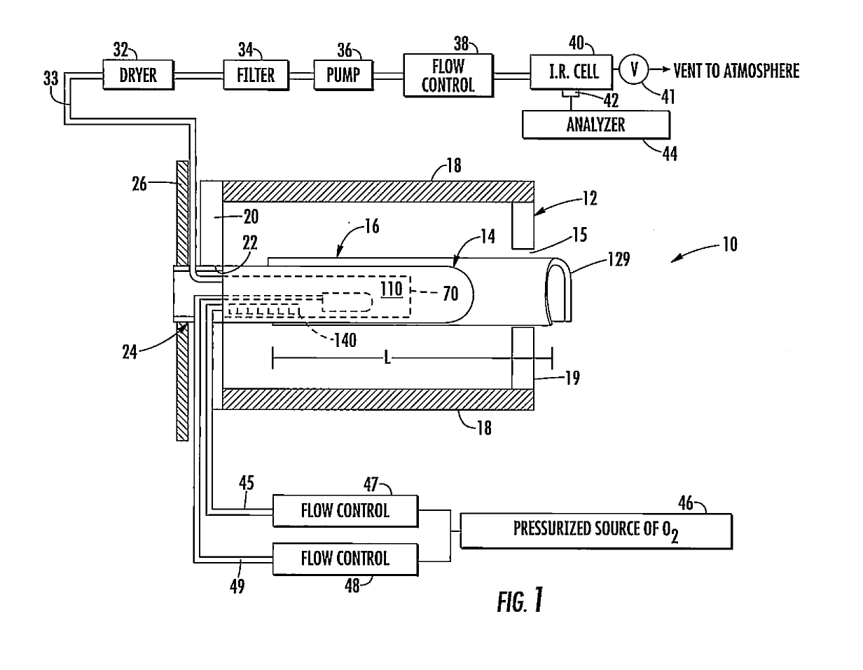

Referring initially to FIG. 1 there is shown an analyzer system 10 which, in the preferred embodiment, is employed for determining the percentage of sulphur content in coal and coke. Although the preferred embodiment is used with these solid materials which are pulverized into powered form for combustion, it is to be understood that the system of the present invention can be used with other solid or liquid materials and for determining other constituents elements of a given specimen.

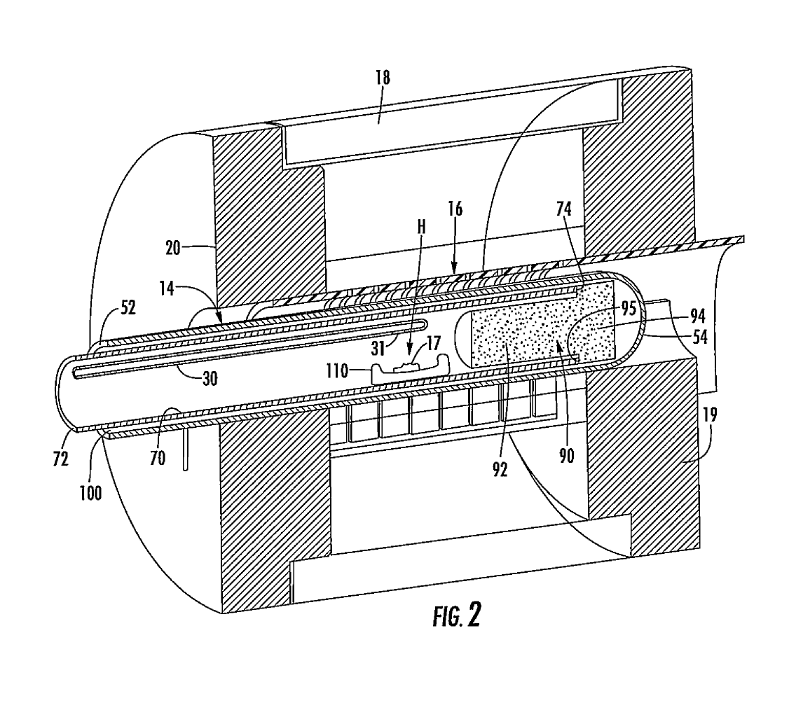

The analyzer system 10 includes a combustion furnace 12, shown partly in cross section in FIG. 1, which includes an outer combustion tube 14 positioned within the furnace. Furnace 12 is a resistance-type furnace, such as a Model No. SC632 commercially available from Leco Corporation in St. Joseph, Mich., U.S.A. The furnace is modified to include an entirely different resistance heater, namely, a unitary curved resistive heating element 16 which concentrically partially surrounds the combustion tube 14, as best seen in FIG. 3. The combustion tube 14 is housed within a refractory housing including a side wall 18, a rear wall 19, and a front wall 20 having a access opening 22 for the extension of one end of the combustion tube 14 through an access port 24 in a front cover panel 26. The resistive heating element 16 is supported within furnace 12 in uniformly spaced relationship to combustion tube 14, as illustrated in FIGS. 2-5. One end 129 of heating element 16 also extends through opening 15 in furnace 12 and is supported by wall 19, as seen in FIGS. 1 and 2. The combustion tube 14 is nearly totally enclosed within the resistance furnace 12.

The resistive heating element 16 is preferably a single piece (i.e., unitary) curved U-shaped elongated silicon carbide element, is somewhat tunnel-shaped, and provides heating temperatures to the interior of the combustion tube 14 from about 1000° C. to a maximum furnace temperature of about 1550° C. The nominal operating temperature for an analysis is 1350° C. Gases from the specimen being fused within the combustion tube 14 are withdrawn from combustion tube 14 through porous plug 90 and through the annular elongated eduction chamber 100 (FIG. 2). Chamber 100 is the annular space between the inner surface of the combustion tube 14 and the outer surface of tube 70 of the combustion system. The eduction pathway includes conduit 33 coupled to an anhydrous dryer 32 (FIG. 1) for removing water from the specimen gas. The specimen gas subsequently travels through a filter 34 and a pump 36 which withdraws the specimen gas from the combustion tube 70. The output of pump 36 is coupled to a flow control 38 for providing a flow rate of approximately 3 liters per minute to the input of an IR cell 40. The output of the IR cell 40 may be vented to the atmosphere through a barometric pressure correction valve 41 to provide a constant back pressure for the gas flow path.

IR cell 40 includes a detector 42 which is electrically coupled to an analyzer instrument 44 including electrical circuits for processing the electrical signals from detector 42 and providing a digital readout of the percentage of sulphur content in the specimen being combusted. Modifications to the specific electrical circuitry can be made to accommodate the system for the particular specimen gas being analyzed. In the preferred embodiment, the IR cell includes a filter for the detection of sulphur dioxide which is a combination of the element sulphur and the oxidizing gas, oxygen, which is employed in the system of the preferred embodiment.

The analyzer system 10 further includes a pressurized source 46 of oxygen gas coupled to a pair of rotometers 47 and 48 which supply the oxygen to the combustion tube 14 through aperture 31 in flood tube 30 via conduit 49. Conduit 45 supplies oxygen to provide an air curtain seal for the open access port 24. The specimen material is combusted by the furnace 12 in the presence of oxygen to convert the sulphur contained within the specimen to sulphur dioxide and carbon to carbon dioxide for subsequent analysis. The combustion system of the present invention provides substantially complete combustion of the specimen for subsequent analysis by the analyzer 44. Having briefly described the overall environment of the analyzer system of the present invention, a detailed description of the combustion furnace with the improved resistive heating element 16 is now presented in conjunction with FIGS. 2-6.

Referring to FIG. 2, there is shown the combustion furnace 12 of the preferred embodiment which includes an outer cylindrical combustion tube 14 made of a suitable refectory material, such as mullite, and having an open cylindrical end 52 and an enclosed opposite end 54 which is rounded, as seen in FIG. 2. Tube 14 has an overall length of about 14.62 inches and an outer diameter of about 2.15 inches and an inner diameter of about 1.9 inches. It is conventionally supported at open end 52 by a generally rectangular mounting block made of stainless steel and having a first circular aperture formed therein for loosely receiving the end 52 of combustion tube 14. These standard mounting components are not shown in the drawings but are disclosed in U.S. Pat. No. 5,064,617, the disclosure of which is incorporated herein by reference. The block also supports an inner combustion tube 70.

Tube 70 is also made of a suitable ceramic material, such as mullite, and has an overall length of approximately 13.62 inches, an outer diameter of about 1.75 inches and an inner diameter of about 1.5 inches. Inner tube 70 is open at a first end 72 and at its opposite end 74. Tube 70 is supported in concentric relationship to tube 14 in a conventional manner by the mounting block near end 72.

The opposite end 74 of the open cylindrical tube 70 is held in concentric spaced relationship with respect to end 54 of tube 14 by means of a porous plug 90 having an overall length of about 3.88 inches and a section 92 having an outer diameter of about 1.34 inches which extends within the end of end 74 of tube 70 a distance of approximately 2.88 inches. Plug 90 has an enlarged cylindrical end 94 with a shoulder 95 which rests against end 74 of tube 70. The diameter of end 94 is approximately 1.82 inches to slide within tube 14 and hold the end 74 of tube 70 in concentric spaced relationship to tube 14.

The porous ceramic plug 90 is made of a reticulated alumina or zirconia material which is commercially available from several sources, including Hi-Tech Ceramics, Inc. The material allows by-products of combustion to flow therethrough and enter the annular space 100. The cross-sectional annular area of eduction chamber or space 100 is approximately 0.74 square inches and provides a slower velocity for combustion gases to recirculate through the hot zone H of the combustion chamber in which a combustion boat 110 is centered. A flow of oxygen is conventionally supplied into the combustion boat 110 through aperture 31 in flood tube 30 to supply an oxidizing and carrier gas for the system and for combusting a specimen 17 held in the boat.

The resistive heating element (i.e., heater) 16, seen in FIGS. 1 and 2, is best seen in FIGS. 3-5 and comprises an elongated U-shaped silicon carbide unitary member which, as best seen in FIG. 3, circumscribes at least an arc of 180° around the combustion tube 14. The silicon carbide heater 16 can be integrally molded in the desired U-shape or formed during manufacturing while in a plastic state. The thickness T of the silicon carbide resistive element 16 is about 3 mm to about 4 mm. The length L (in FIGS. 1 and 5) of the silicon carbide heater 16 is about 320 mm to about 325 mm, which is sufficient to provide a hot zone H in the combustion tube. Heater 16 extends outwardly through the end wall 19 of the furnace 12, such that electrical connections, such as connectors 122 (schematically shown in FIG. 7), can be attached to the resistive heating element and to the power supply 200 shown in FIG. 7. The spacing between the legs of the U-shaped heater 16 is represented by dimension W in FIG. 3 and is about 70 mm. The spacing or gap G between the inner circumferential surface of the heater 16 and the combustion tube 14 is about 7/32 inches. The radius of curvature R (FIG. 3) of resistive heating element 16 is about 35 mm.

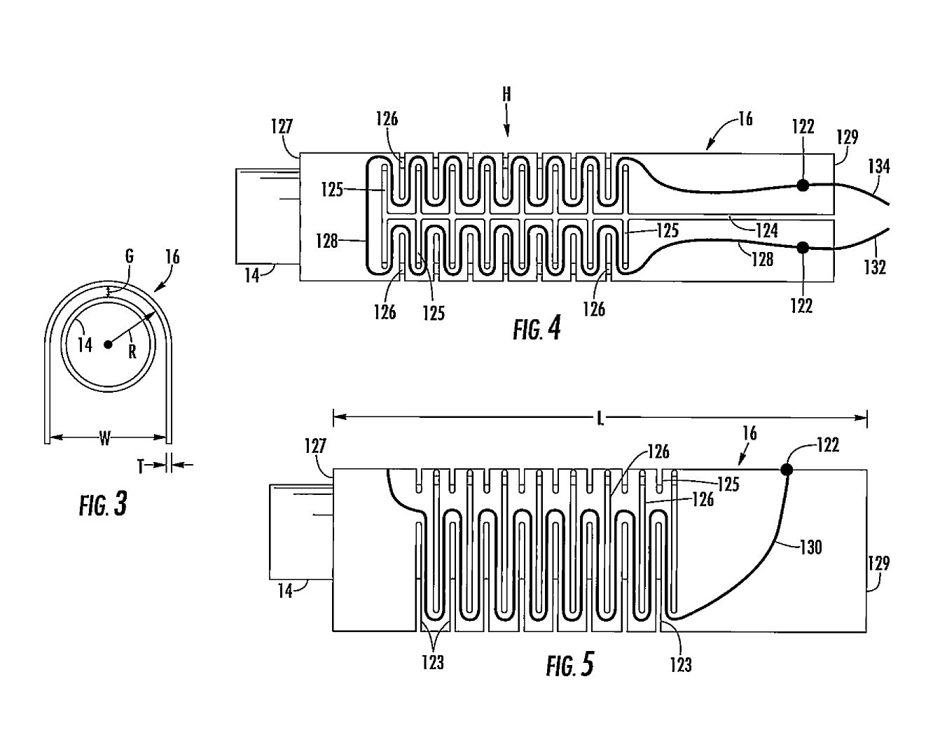

The heater 16, as best seen in FIGS. 4 and 5, is electrically divided into two sections by a horizontal longitudinally extending slot 124, as best seen in FIG. 4. Slot 124 does not extend the entire length of heater 16 but terminates near end 127. The slot 124 divides the heater into two parallel current paths. Alternately staggered transverse slots 125 and 126 define a first pair of parallel resistors 131, 135. Alternately staggered transverse slots 123 and 126 (FIG. 5) define a second pair of parallel resistors 136, 137 (one on each side, with one shown in FIG. 5) coupled in a series current flow path with resistors 131, 135, as shown by the circuit diagram of FIG. 7. This defines, in effect, a series network of two parallel coupled resistors, as illustrated and described in connection with FIG. 7 below. Thus, the slots 123; 124, 125, and 126 define four serpentine electrical current flow paths 128, 130 (FIGS. 4 and 5) through the resistive heating element 16 over a uniform area aligned with the hot spot H of the furnace, as best illustrated in FIG. 2. The slots 123, 124, 125, and 126 have a width of from about 3 mm to about 5 mm and preferably 4 mm. The width of the slots must be sufficient to provide separation of the body of resistance heater 16 into separate resistors 131, 135, 136, and 137 (FIG. 7). The connections to the U-shaped resistive heating element 16 can be made by drilling apertures and placing conductive grommets 122 in them at the end 129 extending from wall 19 of the furnace. Braided wire conductors 132 and 134 are then coupled to the grommets 122 and to the power supply 200 (FIG. 7). The heating element 16 is a single or unitary body which is electrically divided into four electrical current paths by cutting the integral silicon carbide body at 123, 124, 125, and 126, typically after the body of the heater is formed.

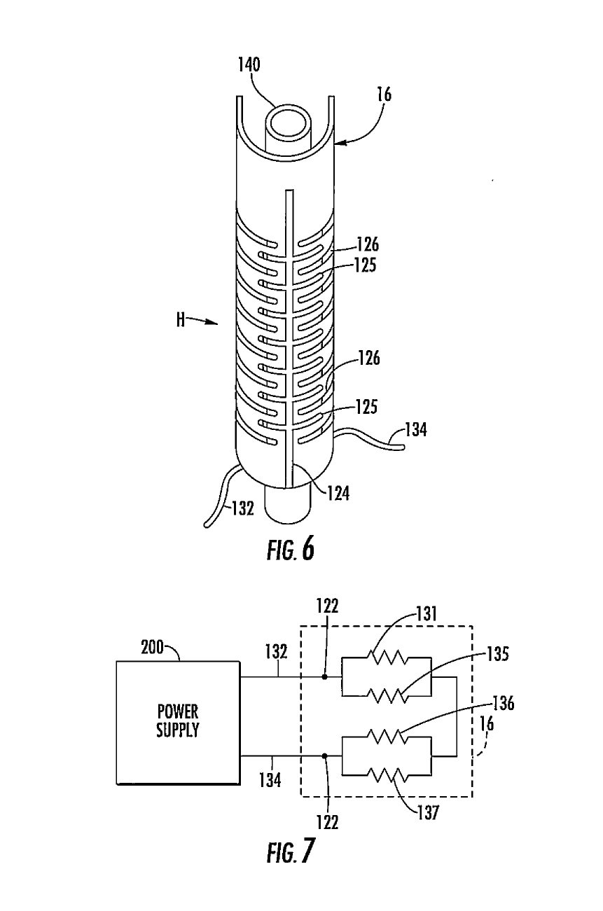

The furnace 12, illustrated in FIGS. 1 and 2, is a horizontally oriented furnace with closed ends 19 and 20 and a horizontally extending cylindrical side wall 18. The horizontally extending cylindrical combustion tube 14 has a closed end 54. In some embodiments, however, the heating element 16 may be used in a vertical furnace, as illustrated in FIG. 6. This vertically oriented furnace environment is described in U.S. Pat. No. 5,246,667. In this embodiment, a ceramic open-ended combustion tube 140 is packed at its lower end with porous material which can support a crucible in the center or hot zone H of the resistive heating element 16. As in the previous embodiment, the heater 16 is divided by a slot 124 and alternately staggered slots 123, 125 and 126 into pairs of parallel resisters in a series flow path which is coupled to the power supply 200 by electrical connections 122 to the conductors 132, 134 on the heating element 16. This can be accomplished by drilling a hole through the silicon carbide on opposite sides of the dividing slot 124 and utilizing suitable conductive grommets for connecting the conductors 132, 134 to the heater 16 and power supply 200, as illustrated in FIG. 7.

In FIG. 7, the power supply can typically be a phase modulated AC voltage supply providing adjustable power to the heater 16, which, as indicated, comprises a series network of two parallel resistors 131, 135 and a second leg of parallel resistors 136, 137 between the connecting terminals 122 of the heater 16. Typically, the resistive heating element 16 uses from 1200 to 1500 watts of power to achieve the 1300° C. to 1550° C. temperature in the hot zone H of the furnace. This represents well over a 50% reduction in power required over conventional spaced rod heaters employed in prior furnace designs. This coupled with the ease of assembly and relatively inexpensive manufacturing costs results in a resistive furnace heating element which is extremely efficient from both manufacturing cost and operational cost standpoints.

Various modifications to the invention, such as dimensional changes and the like, can be made without departing from the spirit or scope of the invention as defined by the appended claims.

The invention claimed is:

1. A combustion furnace for an analyzer comprising:
an elongated cylindrical combustion tube made of a ceramic material;
a generally U-shaped elongated resistive heating element partially surrounding said combustion tube; and
a source of operating power coupled to said resistive heating element.

2. The combustion furnace as defined in claim 1 wherein said resistive heating element circumscribes the combustion tube at least 180°.

3. The combustion furnace as defined in claim 1 wherein said resistive heating element is made of silicon carbide.

4. The combustion furnace as defined in claim 3 wherein said resistive heating element defines a resistance circuit and wherein said resistance circuit is formed by slots formed in said resistive heating element.

5. The combustion furnace as defined in claim 4 wherein said resistance circuit comprises a series circuit path.

6. The combustion furnace as defined in claim 5 wherein said resistance circuit includes two pairs of parallel resistors coupled in series.

7. A heater for a cylindrical combustion tube employed in an analytical instrument, said heater comprising:
an elongated curved resistive element shaped to at least partially surround a cylindrical combustion tube and be positioned in spaced relationship to the combustion tube, wherein said resistive element includes a longitudinally extending slot extending less than the length of said resistive element and a plurality of alternately staggered slots extending on opposite sides of said slot to define serpentine current flow paths between opposite ends of said resistive element; and
a source of electrical power coupled to opposite ends of said resistive element for heating said resistive element and the combustion tube.

8. The heater as defined in claim 7 wherein said resistive element heats the combustion tube to temperatures of from about 1000° C. to about 1550° C.

9. The heater as defined in claim 7 wherein said resistive element is generally U-shaped.

10. The heater as defined in claim 9 wherein said resistive element circumscribes the combustion tube at least 180°.

11. The heater as defined in claim 7 wherein the electrical circuit defined by said slots in said resistive element comprises a series circuit path.

12. The heater as defined in claim 11 wherein said series circuit path includes two pairs of parallel resistors coupled in series.

13. The heater as defined in claim 12 wherein said slots have a width of from about 3 mm to about 5 mm and preferably 4 mm.

14. The heater as defined in claim 7 wherein said resistive element is made of silicon carbide.

15. A combustion furnace for an analyzer comprising:
an elongated cylindrical combustion tube made of a ceramic material;
a unitary resistive heating element surrounding said combustion tube over at least 180° and positioned in spaced relationship thereto; and
a source of operating power coupled to said resistive heating element.

16. The combustion furnace as defined in claim 15 wherein said resistive heating element is an elongated U-shaped member.

17. The combustion furnace as defined in claim 16 wherein said resistive element includes a longitudinal slot and a plurality of alternately staggered slots on opposite sides of said slot to define serpentine current flow paths between opposite ends of said resistive element.

18. The combustion furnace as defined in claim 17 wherein said resistive element defines a series circuit path of multiple resistors.

19. The combustion furnace as defined in claim 18 wherein said circuit path includes two pairs of parallel resistors coupled in series.

20. The combustion furnace as defined in claim 19 wherein said resistive heating element is made of silicon carbide.
